(19) United States
(12) Patent Application Publication
(10) Pub. No.: US 2008/0273738 A1
(43) Pub. Date: Nov. 6, 2008

(54) Inflatable Loudspeaker Enclosure

(75) Inventor: Anthony Smith, Vienna (AT)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/917,046

(22) PCT Filed: Jun. 14, 2006
(86) PCT No.: PCT/IB2006/051907

§ 371 Date: Dec. 10, 2007

(30) Foreign Application Priority Data
Jun. 21, 2005 (EP) 05105495.5

(51) Int. Cl. H04R 1/02

(52) U.S. Cl. 381/386

(57) ABSTRACT

An inflatable loudspeaker enclosure (1, 1′), comprising at least two speakers (4) and an inflatable body (2), wherein the speakers (4) are embedded in the body (2) in such a way that a relative movement of the speakers (4) in relation to each other is enabled. According to a preferred embodiment of the invention, each speaker (4) comprises an edge (5) for fixing the speaker (4) to the body (2). In a further preferred embodiment each speaker (4) is attached to a frame (15) which is embedded in the body (2) in airtight manner.

### FIELD OF THE INVENTION

The invention relates to an inflatable loudspeaker enclosure, comprising at least two speakers and an inflatable body. The invention further relates to an inflatable body for an inflatable loudspeaker enclosure.

### BACKGROUND OF THE INVENTION

A loudspeaker enclosure as mentioned in the first paragraph is known from document U.S. Pat. No. 6,367,579 B1. This document shows a loudspeaker enclosure with an inflatable body and a rigid front speaker mounting element defining two speaker mounting openings. The inflatable body is realized by means of a bladder, which is coupled to the speaker mounting element and is inflatable by means of a valve. The speaker mounting element forms the front wall, whereas the inflatable body forms the side walls and the rear wall of the enclosure. The flexible bladder furthermore has a first wall portion and a second wall portion defining a substantially airtight interior space in-between and may take any desired shape when inflated. Together the speaker mounting element and the bladder form an interior chamber surrounding the drivers of the speakers. The valve, which provides a substantially airtight seal when closed, is in fluid communication with the interior space of the flexible bladder and can be used for inflation and deflation of the bladder. The bladder is inflatable by providing either pressurized gas or expandable foam in the interior. With the known loudspeaker enclosure, unfortunately, it has emerged that due to the rigid speaker mounting plate it is not very convenient to transport or to store, since the mounting plate cannot be folded or convolved.

### OBJECT AND SUMMARY OF THE INVENTION

It is therefore an object of the invention to provide a loudspeaker enclosure of the type mentioned in the first paragraph, which obviates the drawbacks described hereinbefore.

To achieve the object described above, characteristic features according to the invention are provided with a loudspeaker enclosure according to the invention, so that a loudspeaker enclosure according to the invention can be characterized as follows:

An inflatable loudspeaker enclosure, comprising at least two speakers and an inflatable body, wherein the speakers are embedded in the inflatable body in such a way that a relative movement of the speakers in relation to each other is enabled.

The object described above is furthermore achieved by an inflatable body for an inventive inflatable loudspeaker enclosure.

The provision of the characteristic features according to the invention provides the advantage that the package dimension of the loudspeaker enclosure is significantly decreased. Thus, and because the loudspeaker enclosure may be folded or convolved, the loudspeaker enclosure according to the invention is very easy to transport and to store.

It is advantageous, if the speakers are in touch with a medium inflating the body. This measure provides the advantage of simplifying the production of the loudspeaker enclosure since no additional walls which separate the speakers from the inflating medium are necessary there.

It is further advantageous, if the speakers are embedded in the body in airtight manner. This measure provides the advantage of a simple production of the loudspeaker and that escaping of a fluid used for inflating the loudspeaker enclosure is prevented in a simple way.

An advantageous embodiment of the inventive loudspeaker enclosure is furthermore provided if each speaker is attached to a frame being embedded in the body in airtight manner. This measure provides the advantage of a simple assembly of the speakers. Furthermore leak tightness of the body may be tested without assembling speakers to the body (presuming that the body with the empty frame itself is airtight).

It is advantageous, if each speaker comprises its own separate back volume. Hence the speakers are protected when the loudspeaker enclosure is inflated. Otherwise the membrane of a speaker might be damaged due to the differential pressure. In particular the speakers are protected if the loudspeaker enclosure is inflated by means of a liquid. Furthermore the acoustic function may be determined separately for each speaker.

It is beneficial, if the speakers have a common back volume. Thus a good acoustic function is provided due to the comparatively large back volume.

A preferred embodiment of an inventive loudspeaker enclosure is provided, if the loudspeaker enclosure comprises identical speakers. Therewith production of the loudspeaker enclosure is simplified, since identical mounting parts for attaching the speakers can be used. By means of the use of identical mounting parts for attaching the speakers, the manufacturing costs are further decreased.

Finally it is preferred if the loudspeaker enclosure comprises a socket for connecting an electronic device, thus providing the advantage that the loudspeaker enclosure can easily be connected to an external electronic device.

These and other aspects of the invention are apparent from and will be elucidated with reference to the embodiments described hereinafter.

### BRIEF DESCRIPTION OF THE DRAWINGS

The invention will be described in greater detail hereinafter, by way of non-limiting examples, with reference to the embodiments shown in the drawings.

FIG. 1 shows a loudspeaker enclosure according to the invention.

FIG. 2 shows a cross section along the line II-II in FIG. 1.

FIG. 3 shows a cross section of another embodiment of the invention.

FIG. 4 shows a cross section of a further embodiment of the invention.

FIG. 5 shows a perspective view of the embodiment of FIG. 4.

The figures are schematically drawn and not true to scale, and identical reference numerals in different Figures refer to corresponding elements. It will be clear to those skilled in the art that alternative but equivalent embodiments of the invention are possible without deviating from the true inventive concept, and that the scope of the invention will be limited by the claims only.

### DESCRIPTION OF EMBODIMENTS

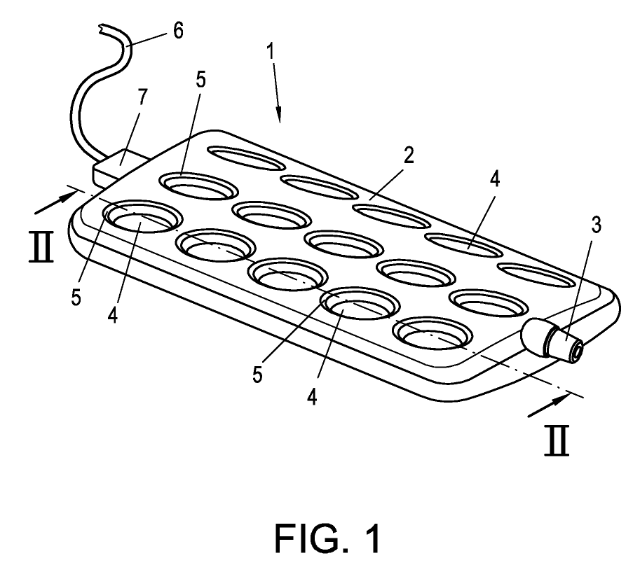

FIG. 1 shows a loudspeaker enclosure 1 according to the invention. The loudspeaker enclosure 1 comprises an inflatable body 2, wherein a valve 3 is provided for inflating the body 2. The valve 3 provides a substantially airtight seal when closed and is in fluid communication with the interior space of the body 2 and can be used for inflation and deflation of the body 2.

Alternatively, a simple stubble can be used instead of the valve 3 as well. In the latter case the body 2 comprises an opening, which is provided for inserting or releasing a medium inflating the body 2 and can be closed by means of the stubble.

The body 2 is inflatable by providing a fluid, e.g. pressurized gas, liquid substances or expandable foam, within the interior of the body 2. The body 2 may be formed as a flexible bladder with a single interior cavity or a plurality of interior cavities respectively. Furthermore, the body 2 may comprise a plurality of independently inflatable cells as well.

After use the body 2 may be deflated by opening the valve 3 or removing the stubble. The deflated loudspeaker enclosure 1 can be rolled up and carried or stored very easily.

Two or more speakers 4 are embedded in the body 2. In the embodiment shown, the loudspeaker enclosure 1 comprises a plurality of speakers 4 forming a matrix of identical speakers 4. But it should be noted that any other arrangement of the speakers 4 is possible as well.

According to a preferred embodiment each speaker 4 comprises an edge 5 for fixing the speakers 4 to the body 2. The edges 5 of the speakers 4 are preferably made of plastics and may be connected to the body 2 by means of heat bonding, edge fusion, gluing or any other suitable method. The speakers 4 are embedded in the body 2 in airtight manner.

The body 2 is preferably made of plastic, e. g. an elastomeric material. Elastomeric materials are shape retainable, but flexibly ductile plastics. Elastomeric materials are for instance Polyurethane, Ethylene Propylene Diene Monomer (EPDM), rubbers based on Polychloroprene etc.

The use of Polyurethane is especially of advantage since the character of the material can be adapted to the desired form very easily. Polyurethane can be made in a variety of textures and hardnesses by varying the particular monomers used and adding other substances. The body 2 of the loudspeaker enclosure 1 can be made more flexible by adding flexible Polyethylene glycol segments between urethane links. A further advantage of the usage of Polyurethane is that the weight of the loudspeaker enclosure 1 is significantly decreased.

The use of EPDM is of particular advantage as well, since this material provides a high flexibility and a high dimensional stability.

Alternatively, the body 2 may be made of a Polyvinyl Chlorid (PVC) compound. By adding Phthalates to the PVC, the flexibility of the body 2 is increased. Phthalates, also known as phthalate esters, are the dialkyl or alkyl aryl esters of 1,2-benzenedicarboxylic acid. When added to PVC, they allow the long polyvinyl molecules to slide against one another. The phthalates show low water solubility and low volatility.

According to a further embodiment the body 2 could be made of Polyethylene terephthalate e. g. by means of a thermoforming process. Polyethylene terephthalate is very lightweight and makes a good gas and fair moisture barrier. It is strong and practically unbreakable.

It should be noted that all the above mentioned materials can be used for producing the edge 5 of the speakers 4 as well. It will be clear to those skilled in the art that the above mentioned materials do not constitute a complete list of materials that can be used for producing the body 2 of the loudspeaker enclosure 1.

In FIG. 1 further a cord 6 for supplying an audio signal from an external electronic device to the speakers 4 is shown. The external electronic device can for instance be a portable audio rendering device, e.g. a radio or CD-player or an MP3 player. The loudspeaker enclosure 1 preferably comprises a socket 7, into which the cord 6 can be plugged. Alternatively, the cord 6 could form a unit with the loudspeaker enclosure 1 as well. Audio signals transmitted to the loudspeaker enclosure 1 are supplied to the speakers 4 by means of wires embedded in the loudspeaker enclosure 1. These wires are not shown in FIG. 1. Furthermore, the speakers 4 are interconnected with each other by means of said wires.

It should be mentioned that the audio signals supplied to the speakers 4 may be transmitted from the electronic device to the loudspeaker enclosure 1 by means of a wireless connection instead of using the cord 6 as well. If the audio signal is transmitted by means of a wireless connection, the loudspeaker enclosure 1 comprises associated receiving means for receiving the audio signal. These receiving means are not shown in the figures and may be for instance conventional “Bluetooth” receiving means. It should further be mentioned that, although the embodiment shown has the form of a mattress, any other shape of the loudspeaker enclosure 1 is in principle possible, e. g. spherical, cubical, the form of a tetrahedron etc.

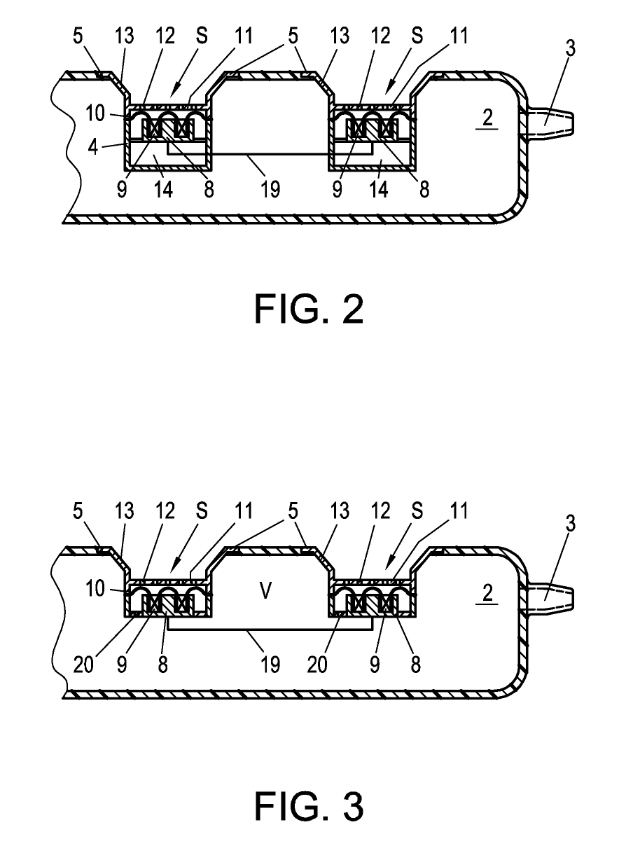

FIG. 2. now shows a cross section of the loudspeaker enclosure 1 of FIG. 1 along the line II-II. The speakers 4 comprise a magnetic circuit 8 and a so-called voice coil 9 connected with a diaphragm 10. When an electrical signal is applied to the voice coil 9 via the cord 6, connecting the loudspeaker enclosure 1 with the external electronic device, the voice coil 9 causes the diaphragm 10 to oscillate and to reproduce sound according to the electric signal applied. On the sound emanating side s of the speaker 4 a front portion 11 is provided, which opposes the diaphragm 10. This front portion 11 has a plurality of through holes 12 through which sound waves emitted from the diaphragm 10 are made to pass. The front portion 11 further comprises outwards inclined sidewall sections 13. At the free ends of the side wall sections 13 the edge 5 for connecting the speaker 4 to the body 2 is provided. According to the embodiment shown, the speakers 4 each comprise a back volume 14 of their own. The speakers 4 are furthermore interconnected by means of a wire 19.

According to FIG. 3, which shows another embodiment of the invention, the speakers 4 of the loudspeaker enclosure may comprise a common back volume V as well. In the embodiment shown, the common back volume V is constituted by the interior space of the body 2 and the speakers 4 are in touch with the medium or fluid respectively inflating the body 2. It is particularly of advantage here if the fluid is gaseous, e. g. air. The interior spaces of each speaker 4 may communicate with the volume V by means of an opening 20. Due to the common back volume V, the acoustic function of the loudspeaker enclosure 1 is improved significantly.

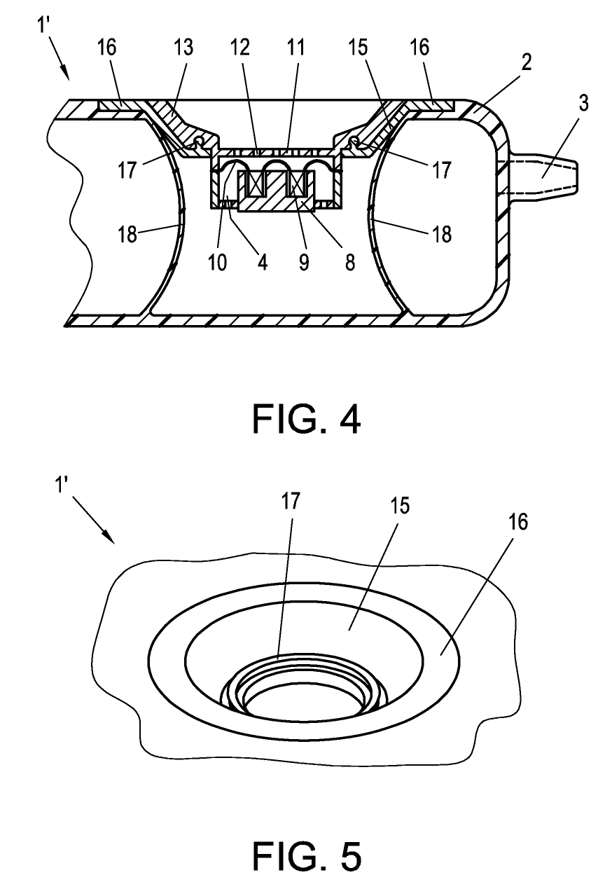

As shown now in FIG. 4, a loudspeaker enclosure 1′ may also comprise a frame 15 which is connected to the body 2 in airtight manner. The frame 15 comprises edges 16 which are connected to the body 2. The edges and the body 2 may be interconnected by means of heat bonding, edge fusion, gluing or any other suitable method. The frame 15 defines an opening for inserting the speaker 4. The frame 15 further comprises a lug 17. According to this embodiment of the invention, the front portion 11 of the speaker 4 comprises side walls 13 with a groove corresponding with the lug 17. The lug 17 can be pressed into the groove of the side walls 13, so that the speaker 4 is clipped into the frame 15. According to the embodiment shown, the body 2 further comprises interior sidewalls 18 supporting the frame 15 and defining a hollow cell constituting the back volume for the speaker 4. Alternatively, the loudspeaker 1′ enclosure may be realized without the interior side walls 18. In the latter case the speakers 4 of the loudspeaker enclosure 1′ may share a common back volume, too.

FIG. 5 finally shows a perspective view of the embodiment of FIG. 4. As stated before, the frame 15 is of a conic shape, wherein the lug 17 has the form of a ring defining an opening for inserting the speaker 4 into the body 2.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The words “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of hardware. The mere fact that certain measures are recited in mutually different dependent claims does not indicate that a combination of these measures cannot be used to advantage.

1. An inflatable loud speaker enclosure, comprising at least two speakers and an inflatable body, wherein the speakers are embedded in the body in such a kind that a relative movement of the speakers by in relation to each other is enabled.

2. An inflatable loud speaker enclosure as claimed in claim 1, wherein the speakers are in touch with a medium inflating the body.

3. A loudspeaker enclosure as claimed in claim 1, wherein the speakers are air tight embedded in the body.

4. A loudspeaker enclosure as claimed in claim 1, wherein each speaker is attached to a frame being air tight embedded in the body.

5. A loudspeaker enclosure as claimed in claim 1, wherein each speaker comprises its own separate back volume.

6. A loudspeaker enclosure as claimed in claim 1, wherein the speakers have a common back volume.

7. A loudspeaker enclosure as claimed in claim 1, wherein the loudspeaker enclosure comprises identical speakers.

8. A loudspeaker enclosure as claimed in claim 1, wherein the loudspeaker enclosure comprises a socket for connecting an electronic device.

9. An inflatable body for an inflatable loudspeaker enclosure as claimed in one of the claims 1.
